(19) United States
(12) Patent Application Publication
(10) Pub. No.: US 2026/0218921 A1
(43) Pub. Date: Jul. 30, 2026

(54) A DESICCANT DEHUMIDIFIER AND A METHOD, PERFORMED BY A CONTROL DEVICE, FOR CONTROLLING A DESICCANT DEHUMIDIFIER

(71) Applicant: MUNTERS EUROPE AKTIEBOLAG, Kista (SE)

(72) Inventors: Magnus Carlsson, Vallentuna (SE); Roine Ericsson, Sollentuna (SE)

(21) Appl. No.: 19/137,211

(22) PCT Filed: Nov. 10, 2023
(86) PCT No.: PCT/EP2023/081417

§ 371 Date: Jun. 9, 2025

(30) Foreign Application Priority Data
Dec. 15, 2022 (SE) 2251468-1

(51) Int. Cl. F24F 3/14; B01D 53/06; B01D 53/26; B01D 53/30; F24F 110/20

(52) U.S. Cl. CPC F24F 3/1423; B01D 53/06; B01D 53/261; B01D 53/30; B01D 2257/80; B01D 2258/06; B01D 2259/40086; B01D 2259/4009; F24F 2003/144; F24F 2003/1464; F24F 2110/20; F24F 2221/34

(57) ABSTRACT

The disclosure relates to a method, performed by a control device (200), for controlling a desiccant dehumidifier (1): the method comprises the steps of: controlling (s101) the heater device (28) arranged in fluid communication with the regeneration air circuit (12) upstream of the desiccant rotor (2) to provide a substantially constant temperature of the regeneration air (14); and controlling (s102) the volume flow of regeneration air (14) with the substantially constant temperature through the regeneration sector (16) based on a predetermined target humidity in the regeneration sector (16) of the desiccant rotor (2). The disclosure further relates to a computer program, a computer-readable medium (202) having stored thereon the computer program and a desiccant dehumidifier (1).

### TECHNICAL FIELD

The present invention relates to a method, a computer program, a computer-readable medium and a desiccant dehumidifier. More specifically, the disclosure relates to a method performed by a control device, for controlling a desiccant dehumidifier. The present invention also relates to a computer program, a computer-readable medium having stored thereon the computer program and a desiccant dehumidifier comprising: a desiccant rotor, which is rotatably arranged about a centre axis of the desiccant rotor; a process air circuit arranged to conduct process air through a process sector of the desiccant rotor; a regeneration air circuit arranged to conduct regeneration air through a regeneration sector of the desiccant rotor; a fan arranged in the regeneration air circuit, downstream of the desiccant rotor, which fan is configured to generate a flow of regeneration air in the regeneration air circuit; and a heater device arranged in fluid communication with the regeneration air circuit upstream of the desiccant rotor.

### BACKGROUND ART

Dehumidifiers, such as sorption dehumidifiers and condensate dehumidifiers, are used for separating and removing moisture from air. A sorption dehumidifier typically comprises a dehumidifying element in the form of a wheel or rotor holding desiccant material, which is effective in attracting and retaining water vapour. The desiccant rotor may be divided in two sectors, a process sector and a regeneration sector. The airflow to be dehumidified, process air, will pass through the process sector of the desiccant rotor, and the desiccant material in the rotor extracts moisture from the process air, so that it can leave the rotor as dried air. Simultaneously, the desiccant material is regenerated by another air stream, regeneration air stream, which flows through the regeneration sector, all the while the desiccant rotor may rotate slowly about its longitudinal axis. By means of the simultaneous dehumidification of the process air and regeneration of desiccant material, the dehumidifier can be operated continuously.

US2007056307 discloses an example of a dehumidifier having a desiccant wheel.

The air that flows through the regeneration sector is heated by a heater device. The heat in the heater device may be generated by electric power. The airflow through the regeneration sector may be generated by a fan driven by electric power. The heated air, which flows through the regeneration sector, releases humidity from the desiccant rotor and thus dries the rotor.

### SUMMARY

The releasing of humidity from the desiccant rotor by regeneration air will reduce the humidity in the rotor, so that the desiccant rotor can extract moisture from the process air passing through the process sector. However, heating the regeneration air for drying the desiccant rotor is energy demanding and costly. There are known desiccant dehumidifiers, which use unlimited power to quickly reach steady state but care little about the energy use.

Further, there are known heater devices for heating the regeneration air, which may not deliver a uniform temperature distribution of the regeneration air in the desiccant rotor. Therefore, it may be difficult to control the desiccant dehumidifier, which may result in an unnecessary dry desiccant rotor, due to excessive heating of the desiccant rotor.

In some occasions, it may be beneficial to run the desiccant dehumidifier in different operation modes depending on the situation and needs of the air in the space or the room to be treated. In some situations, a low cost for drying the room is prioritized. In other situations, the humidity in the same room must be lowered in a short period of time, using the same desiccant dehumidifier. In some further situations, it may be important to avoid condensation of fluid on walls and surfaces in the room.

Therefore, it is a need for an improved desiccant dehumidifier and a method for controlling the desiccant dehumidifier, which in one operation mode decreases the energy demands for treatment of the air in a space or a room, in another operation mode decreases the humidity in the same space or room in a short period of time and in a further operation mode prevents condensation on walls and surfaces in the space or the room.

It is an object of the present disclosure to mitigate, alleviate or eliminate one or more of the above-identified deficiencies and disadvantages in the prior art and to solve at least the above-mentioned problem.

A further objective of the present invention is to achieve a desiccant dehumidifier and a method for controlling the desiccant dehumidifier, which in one operation mode decreases the energy demands for treatment of the air in a space or a room and thus decreases the heating costs of the regeneration air.

A further objective of the present invention is to achieve a desiccant dehumidifier and a method for controlling the desiccant dehumidifier, which in one operation mode decreases the humidity in the same space or room in a short period of time.

A further objective of the present invention is to achieve a desiccant dehumidifier and a method for controlling the desiccant dehumidifier, which in one operation mode prevents condensation on walls and surfaces in the space or the room.

These objectives are achieved by the method initially defined, further comprising the steps of: controlling the heater device to provide a substantially constant temperature of the regeneration air; and controlling the volume flow of regeneration air with the substantially constant temperature through the regeneration sector based on a predetermined target humidity in the regeneration sector of the desiccant rotor.

The desiccant dehumidifier is configured to treat air in order to separate and remove moisture, such as water vapour from the air. Dry air may be conveyed from the desiccant dehumidifier to a space or a room in which the humidity in the air should be controlled. The desiccant rotor holding desiccant material, which is effective in attracting and retaining water vapour. The process airflow will flow in the process air circuit and pass through the desiccant rotor. Desiccant material in the main desiccant rotor extracts moisture from the process air in the process airflow, so that the process air can leave the desiccant rotor as dried air. The extracted moisture from the process air is removed from the desiccant material in the desiccant rotor by the regeneration airflow, which flows in the regeneration air circuit and through the desiccant rotor. The removed moisture from the desiccant material is conveyed from the desiccant rotor by the regeneration airflow in the regeneration air circuit downstream of the desiccant rotor. The fan, which is arranged downstream of the desiccant rotor, is configured to generate the regeneration airflow in the regeneration air circuit.

The heater device is configured to increase the temperature of the regeneration air in the regeneration air circuit. The heater device may generate a constant or a substantially constant temperature of the regeneration air. Further, the heater device may generate an evenly distributed or a substantially evenly distributed regeneration air temperature through the regeneration sector. The substantially constant temperature of the regeneration air provided by the heater device may be selected based on the selected predetermined target humidity. Further, the regeneration airflow is controlled to obtain a targeted moisture outlet content with the regeneration air fan. The heater device may have a flattening effect on the temperature distribution, thus making it uniform. To optimize the energy use of the unit, it is beneficial not to over dry the desiccant rotor in the regenerative sector since the extra dehumidification capacity is requiring excessive heat energy, which is costly. In order to avoid over drying, also when the regeneration airflow in the desiccant dehumidifier is varying, the control device may limit the regeneration airflow to a pre-calculated value to make sure that the energy use is kept low. This will make the variations of the regeneration airflow smoother and slower but will save costs where reaching the target humidity is not time critical. The heater device may thus in a in a first operation mode be controlled to reach a target humidity smoothly with a low overall energy use. The humidity in a space or in a room may thus be controlled with a variable regeneration airflow that is limited by a preset value to minimize the overall energy use to reach the target room humidity. The method for controlling the desiccant dehumidifier, in this first operation mode may decrease the energy demands for treatment of the air in a space or a room and thus decreases the heating costs of the regeneration air. Further, the desiccant dehumidifier may be switched to a second operation mode for decreasing the humidity in the same space or room in a short period of time. The heater device may be controlled to provide an increased and substantially constant temperature of the regeneration air and controlling the volume flow of regeneration air with the increased and substantially constant temperature through the regeneration sector based on a lower predetermined target humidity in the desiccant rotor. Such selection of the second operation mode may increase the energy demands on both the heater device and on the fan arranged in the regeneration circuit, but reaching the target temperature in a short period of time.

The desiccant dehumidifier may further comprise a first humidity sensor arranged in the process air circuit downstream of the desiccant rotor, wherein the step of controlling the volume flow of regeneration air through the regeneration sector is further based on a current humidity in the desiccant rotor determined by means of the first humidity sensor. The first humidity sensor arranged in the process air circuit may be arranged in the vicinity of the desiccant rotor or at a limited distance of the desiccant rotor. The first humidity sensor is configured to send signals to the control device about the humidity sensed in the process air circuit downstream of the rotor. The humidity in the process air circuit downstream the desiccant rotor may in some operation modes of the desiccant dehumidifier be in the range of 0%-10% RH, preferably in the range of 0%-5% RH, and most preferably in the range of 0%-2% RH. The humidity in the process air circuit downstream the desiccant rotor indicates the humidity in the regeneration sector of the desiccant rotor. This way, the humidity in the regeneration sector of the desiccant rotor may be controlled.

The desiccant dehumidifier may further comprise a second humidity sensor arranged in the regeneration air circuit downstream of the desiccant rotor, wherein the step of controlling the volume flow of regeneration air through the regeneration sector is further based on a current humidity in the desiccant rotor determined by means of the second humidity sensor. The second humidity sensor arranged in the regeneration air circuit may be arranged in the vicinity of the desiccant rotor or at a limited distance of the desiccant rotor. The second humidity sensor is configured to send signals to the control device about the humidity sensed in the regeneration air circuit downstream of the rotor. The humidity in the regeneration air circuit downstream the desiccant rotor may indicate the humidity in the regeneration sector of the desiccant rotor. The humidity in the regeneration air circuit downstream the desiccant rotor may in some operation modes of the desiccant dehumidifier be in the range of 50%-100% RH, preferably in the range of 65%-95% RH, and most preferably in the range of 70%-90% RH. This way, the humidity in the regeneration sector of the desiccant rotor may be controlled. The second humidity sensor may be arranged in combination with the first humidity sensor in the desiccant dehumidifier. Values from the second humidity sensor may be analysed in combination with values from the first humidity sensor in the desiccant dehumidifier.

The desiccant dehumidifier may further comprise a third humidity sensor arranged in a space, which is fluidly connected to the process air circuit, wherein the step of controlling the volume flow of regeneration air through the regeneration sector is further based on a target running time of the desiccant dehumidifier for reaching a target humidity in the space, determined by means of the third humidity sensor. The third humidity sensor may be arranged in the space to be dried by the desiccant dehumidifier. The third humidity sensor is configured to send signals to the control device about the humidity sensed in the space. The desiccant dehumidifier may controlled for decreasing the humidity to the target humidity in the space based on a target running time of the desiccant dehumidifier. The heater device may be controlled to provide the substantially constant temperature at a suitable temperature level of the regeneration air. By controlling the fan, the volume flow of regeneration air may be controlled at a suitable level. The suitable level of the temperature of the regeneration air and the suitable level of the volume flow of regeneration air may be selected for reaching a target humidity in the space at the target running time of the desiccant dehumidifier. The third humidity sensor may be arranged in combination with the first and/or the second humidity sensor in the desiccant dehumidifier. Values from the third humidity sensor may be analysed in combination with values from the first and/or the second humidity sensor in the desiccant dehumidifier.

The desiccant dehumidifier may further comprise a dew point sensor arranged in a space, which is fluidly connected to the process air circuit, wherein the step of controlling the volume flow of regeneration air through the regeneration sector is further based on a target dew point humidity determined by the dew point sensor. The dew point sensor may be arranged in the space to be dried by the desiccant dehumidifier. The dew point sensor is configured to send signals to the control device about the dew point sensed in the space. In some situations, it may be important to avoid condensation of fluid on walls and surfaces in the room. The volume flow of regeneration air through the regeneration sector may thus be controlled for reaching the target dew point humidity. The dew point sensor may be arranged in combination with the first, second and/or the third humidity sensor in the desiccant dehumidifier.

The step of controlling the volume flow of regeneration air through the regeneration sector may comprise controlling the speed of the fan for controlling the volume flow of the regeneration air. The fan may be connected to the control device. The control device may control the speed of the fan for controlling the volume flow of the regeneration air through the regeneration sector.

The desiccant dehumidifier may further comprise a damper arranged in the regeneration air circuit downstream of the desiccant rotor, wherein the step of controlling the volume flow of regeneration air through the regeneration sector comprises controlling the damper for controlling the volume flow of regeneration air. The damper may be controlled in positons between an open position and a closed position. In the fully open position, a large volume flow of regeneration air may pass the regeneration sector. In the positions between the open and closed position, the volume flow of regeneration air through the regeneration sector may be restricted. The damper may be electrically or pneumatically controlled.

The desiccant dehumidifier may further comprise a purge air circuit arranged to conduct purge air through a purge sector of the desiccant rotor, which purge air circuit is arranged in fluid communication with the process air circuit upstream of the desiccant rotor and to the regeneration air circuit upstream of the heater device, wherein the method comprises the further step of: controlling the volume flow of purge air together with regeneration air through the desiccant rotor based on the predetermined target humidity in the desiccant rotor. In addition to the process airflow and the regeneration airflow also a purge airflow is configured to pass through the desiccant rotor. The purge airflow is arranged to flow in a purge air circuit of the desiccant dehumidifier. The temperature of the desiccant rotor will increase when the regeneration airflow passes through the rotor. In order to effectively trap moist and water from the process airflow in the desiccant rotor, there is an ambition to decrease the temperature of that part of the desiccant rotor in which the regeneration airflow has passed through the desiccant rotor. Therefore, the purge airflow is directed through the purge sector. The purge airflow flowing through the purge sector may have a temperature, which is lower than the temperature of the regeneration airflow passing through the desiccant rotor. Thus, the purge airflow flowing through the purge sector will decrease the temperature of that part or sector of the desiccant rotor in which the regeneration airflow has passed through the desiccant rotor. Due to the increased temperature of the desiccant rotor by the regeneration airflow, the temperature of the air in the purge airflow will increase when it flows through the purge sector. The purge flow with increased temperature is directed to the regeneration air circuit upstream of the heater device. The heater device may generate a substantially constant and evenly distributed regeneration air temperature, which may be beneficial for energy recovery in the purge air sector. Further, the regeneration airflow may be controlled to obtain a targeted moisture outlet content by the fan in the regeneration circuit, which simultaneously also controls the purge air flow. There are two energy related benefits of this procedure: the heater device may have a flattening effect on the temperature distribution, thus making it more uniform, and the mixing temperature of the purge outlet air and heated regeneration air will be substantially constant/similar regardless of the air flow/capacity because the heat transfer effects in the desiccant rotor will remain substantially constant.

The step of controlling the volume flow of the purge air together with regeneration air through the desiccant rotor may comprise controlling the speed of the fan for controlling the volume flow of the purge air and the regeneration air through the desiccant rotor. The volume flow of both the purge air and the regeneration air through the desiccant rotor may be controlled by the speed of the fan. The fan may be connected to the control device. Since the fan is arranged downstream of the desiccant rotor, a negative pressure may be generated by the fan in the regeneration and purge air circuits. The volume flow of both the purge air and the regeneration air through the desiccant rotor may be controlled by the damper. Further, the volume flow of both the purge air and the regeneration air through the desiccant rotor may be controlled by the damper, together with a selected speed of the fan.

The step of controlling the volume flow of the purge air together with regeneration air through the desiccant rotor may comprise controlling the volume flow of the purge air through a purge sector of the desiccant rotor in relation to the volume flow of the regeneration air through the regeneration sector of the desiccant rotor. The predetermined target humidity in the regeneration sector of the desiccant rotor may be used to change the ratio between volume flow of the purge air and the regeneration air to reach predefined targets. The operating modes of the desiccant dehumidifier can either dry the air at low cost or to dry the air fast. For example, to make the desiccant dehumidifier to dry air fast, the desiccant dehumidifier can reach higher dry-capacity values, for example expressed in weight per time period, when lowering the ratio between volume flow of the purge air and the regeneration air. In order to vary the ratio, the desiccant dehumidifier may be provided with an adjustable purge air inlet. Such inlet may choke the volume flow of the purge air as a function of the volume flow of the regeneration air. A high volume flow of the regeneration air with a low ratio between the volume flow of the purge air and the volume flow of the regeneration air may reduce the time to reach the predetermined target humidity.

The step of controlling the volume flow of regeneration air with the substantially constant temperature through the regeneration sector based on a predetermined target humidity in the regeneration sector of the desiccant rotor my comprise controlling the volume flow of regeneration air with the substantially constant temperature through the regeneration sector based on a predetermined target humidity in the regeneration sector which is larger than 0% RH. The predetermined target humidity may be a humidity in the regeneration sector which may be larger than 0% RH. When the humidity in the regeneration sector of the desiccant rotor is larger than 0% RH, the desiccant rotor may not be unnecessary dry, due to excessive heating of the desiccant rotor. Thus, the heating costs of the regeneration air decreases. The humidity in the regeneration sector may also depend on the extension or thickness of the rotor in the axial direction, the rotational speed of the rotor and the volume flow of the regeneration air through the regeneration sector.

The present disclosure also relates to a computer program comprising instructions which, when the program is executed a data processing unit of a control device of a desiccant dehumidifier, cause the control device to carry out the method disclosed above. The invention further relates to a computer-readable medium having stored there on the computer program. The method may be comprised in pre-programmed software, which may be implemented into a production unit suitable for utilizing the method. The pre-programmed software may be stored in the control device. Alternatively, or in combination, the software may be stored in a memory or in a computer at a distance from the control device.

The above-mentioned objectives are also achieved by the desiccant dehumidifier initially defined, further comprising the features that the control device may be configured to control the heater device to provide a substantially constant temperature of the regeneration air; and to control the volume flow of regeneration air through the regeneration sector based on a predetermined target humidity in the regeneration sector of the desiccant rotor. The control device may be configured to control the heater device in order to provide a constant or a substantially constant temperature of the regeneration air. The heater device may be driven by electric power. The electric power to the heater device may be controlled by the control device. The substantially constant temperature of the regeneration air provided by the heater device may be selected based on the selected predetermined target humidity. The selected level of the substantially constant temperature is controlled by the control device. Further, the control device may be configured to control the fan in order to achieve the volume flow of regeneration air through the regeneration sector.

According to an example, the heater device comprises a PTC heater. The PTC heater may generate a constant or substantially constant regeneration temperature. Further, the PTC heater may generate an evenly or substantially evenly distributed regeneration air temperature through the regeneration sector. Further, the regeneration airflow is controlled to obtain a targeted moisture outlet content with the regeneration air fan. The PTC heater may have a flattening effect on the temperature distribution, thus making the temperature uniform. The PTC is an abbreviation of positive temperature coefficient.

The predetermined target humidity in the regeneration sector of the desiccant rotor may be larger than 0% RH. When the humidity in the regeneration sector of the desiccant rotor is larger than 0% RH, the desiccant rotor may not be unnecessary dry, due to excessive heating of the desiccant rotor. Thus, the heating costs of the regeneration air decreases.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates in a view of perspective, a desiccant dehumidifier according to an example;

FIG. 2 schematically illustrates a desiccant dehumidifier connected to a space or a room, according to an example;

FIG. 3 schematically illustrates a desiccant dehumidifier connected to a space or a room, according to a further example;

FIG. 4 shows a flowchart of a method according to an example; and

FIG. 5 schematically illustrates a control device according to an example.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

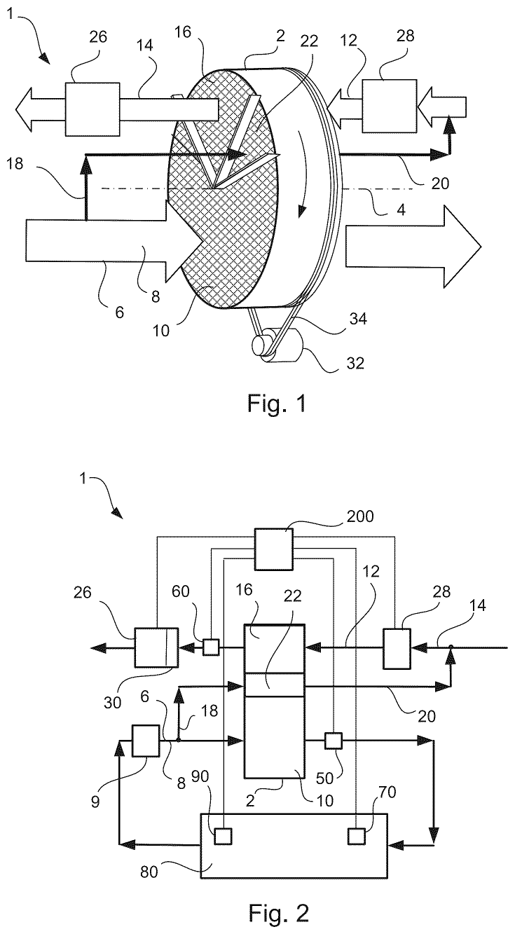

FIG. 1 schematically illustrates in a view of perspective, a desiccant dehumidifier 1 according to an example. The desiccant dehumidifier 1 comprises a desiccant rotor 2, which is rotatably arranged about a centre axis 4. A process air circuit 6 is arranged to conduct process air 8 through a process sector 10 of the desiccant rotor 2. A regeneration air circuit 12 is arranged to conduct regeneration air 14 through a regeneration sector 16 of the desiccant rotor 2. A purge air circuit 18 is arranged to conduct purge air 20 through a purge sector 22. The purge air circuit 18 is arranged in fluid communication with the process air circuit 6 upstream of the desiccant rotor 2 and to the regeneration air circuit 12 upstream of a heater device 28. The heater device 28 is arranged in fluid communication with the regeneration air circuit 12 upstream of the desiccant rotor 2. The heater device 28 may comprise a PTC heater. A fan 26 is arranged in the regeneration air circuit 12, downstream of the desiccant rotor 2, which fan 26 is configured to generate a flow of regeneration air 14 in the re-generation air circuit 12. A motor 32 is arrange to rotate the desiccant rotor 2 about the centre axis 4 via a transmission 34.

FIG. 2 schematically illustrates a desiccant dehumidifier 1 connected to a space 80 or a room, according to an example. In FIG. 2, the desiccant rotor 2 comprises the process sector 10, the regeneration sector 16 and the purge sector 22. The process air circuit 6 is arranged to conduct process air 8 through the process sector 10. A process fan 9 is arranged in the process air circuit 6 to generate a flow of the process air 8 in the process air circuit 6. The regeneration air circuit 12 is arranged to conduct regeneration air 14 through the regeneration sector 16. The purge air circuit 18 is arranged to conduct purge air 20 through the purge sector 22. The fan 26 is arranged in the regeneration air circuit 12, downstream of the desiccant rotor 2. A damper 30 arranged in the regeneration air circuit 12 downstream of the desiccant rotor 2 The heater device 28 is arranged in fluid communication with the regeneration air circuit 12 upstream of the desiccant rotor 2. The desiccant dehumidifier 1 further comprises a first humidity sensor 50 arranged in the process air circuit 6 downstream of the desiccant rotor 2, a second humidity sensor 60 is arranged in the regeneration air circuit 12 downstream of the desiccant rotor 2 and third humidity sensor 70 is arranged in a space 80, which is fluidly connected to the process air circuit 6. The desiccant dehumidifier 1 further comprises a dew point sensor 90 arranged in the space 80. A control device 200 is connected to the fan 26, the damper 30, the heater device 28, the first, second and third humidity sensors 50, 60, 70, and to the dew point sensor 90. The damper 30 may be controlled for controlling the volume flow of regeneration air 14 through the regeneration sector 16. Further, the volume flow of both the purge air 20 and the regeneration air 14 through the desiccant rotor 2 may be controlled by the damper 30, together with a selected speed of the fan 26 arranged in the regeneration air circuit 12.

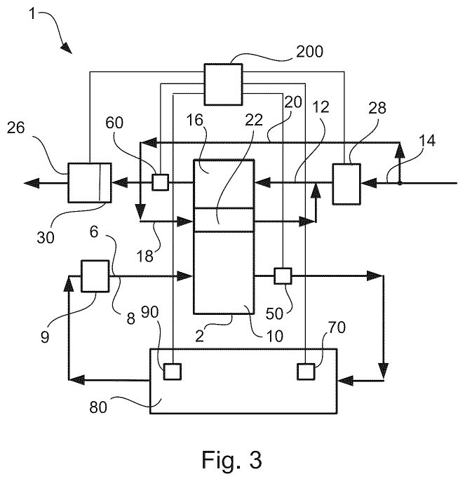

FIG. 3 schematically illustrates a desiccant dehumidifier 1 connected to a space 80 or a room, according to a further example. In FIG. 3 the purge air circuit 18 is arranged in fluid communication with the regeneration air circuit 12 upstream of the heater device 28. After passing the purge sector of the desiccant rotor 2, the purge air circuit is arranged in fluid communication with the regeneration air circuit 12 downstream of the heater device and upstream of the desiccant rotor 2.

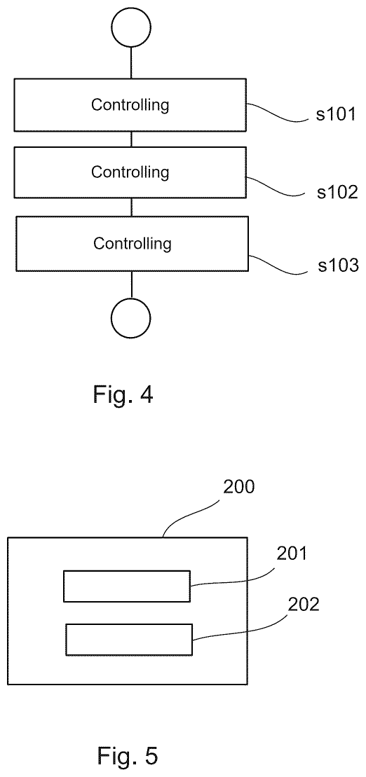

FIG. 4 shows a flowchart of a method according to an example. The method is performed by the control device 200, for controlling a desiccant dehumidifier 1. The method relates to the desiccant dehumidifier 1 disclosed in FIGS. 1 and 2. The desiccant dehumidifier 1 thus comprises the desiccant rotor 2, which is rotatably arranged about the centre axis 4 of the desiccant rotor 1; the process air circuit 6 arranged to conduct process air 8 through the process sector 10 of the desiccant rotor 2; the regeneration air circuit 12 arranged to conduct regeneration air 14 through the regeneration sector 16 of the desiccant rotor 2; the fan 26 arranged in the regeneration air circuit 12, downstream of the desiccant rotor 2, which fan 26 is configured to generate the flow of regeneration air 14 in the re-generation air circuit 12; and the heater device 28 arranged in fluid communication with the regeneration air circuit 12 upstream of the desiccant rotor 2.

The method comprises the steps of: controlling s101 the heater device 28 to provide a substantially constant temperature of the regeneration air 14; and controlling s102 the volume flow of regeneration air 14 with a substantially constant temperature through the regeneration sector 16 based on a predetermined target humidity in the desiccant rotor 2.

The desiccant dehumidifier 1 further comprises the first humidity sensor 50 arranged in the process air circuit 6 downstream of the desiccant rotor 2, wherein the step of controlling s102 the volume flow of regeneration air 14 through the regeneration sector 16 is further based on a current humidity in the desiccant rotor 2 determined by means of the first humidity sensor 50. The desiccant dehumidifier 1 further comprises the second humidity sensor 60 arranged in the regeneration air circuit 12 downstream of the desiccant rotor 2, wherein the step of controlling s102 the volume flow of regeneration air 14 through the regeneration sector 16 is further based on a current humidity in the desiccant rotor 2 determined by means of the second humidity sensor 60. The desiccant dehumidifier 1 further comprises the third humidity sensor 70 arranged in a space 80, which is fluidly connected to the process air circuit 6, wherein the step of controlling s102 the volume flow of regeneration air 14 through the regeneration sector 16 is further based on a target running time t of the desiccant dehumidifier 1 for reaching a target humidity TH in the space 80, determined by means of the third humidity sensor 70. The desiccant dehumidifier 1 further comprises the dew point sensor 90 arranged in a space 80, which is fluidly connected to the process air circuit 6, wherein the step of controlling s102 the volume flow of regeneration air 14 through the regeneration sector 16 is further based on a target dew point humidity °DP determined by the dew point sensor 90. The step of controlling s102 the volume flow of regeneration air 14 through the regeneration sector 16 comprises controlling the speed of the fan 26 for controlling the volume flow of the regeneration air 14. The desiccant dehumidifier 1 further comprises the damper 30 arranged in the regeneration air circuit 12 downstream of the desiccant rotor 2, wherein the step of controlling s102 the volume flow of regeneration air 14 through the regeneration sector 16 comprises controlling the damper 30 for controlling the volume flow of regeneration air 14. Further, the volume flow of both the purge air and the regeneration air through the desiccant rotor may be controlled by the damper, together with a selected speed of the fan.

The desiccant dehumidifier 1 further comprises the purge air circuit 18 arranged to conduct purge air 20 through the purge sector 22 of the desiccant rotor 2, which purge air circuit 18 is arranged in fluid communication with the process air circuit 6 upstream of the desiccant rotor 2 and to the regeneration air circuit 12 upstream of the heater device 28, wherein the method comprises the further step of: controlling s103 the volume flow of purge air 20 together with regeneration air 14 through the desiccant rotor 2 based on the predetermined target humidity in the desiccant rotor 2. The step of controlling s103 the volume flow of the purge air 20 together with regeneration air 14 through the desiccant rotor 2 comprises controlling the speed of the fan 26 for controlling the volume flow of the purge air 20 and the regeneration air 14 through the desiccant rotor 2. The step of controlling s103 the volume flow of the purge air 20 together with regeneration air 14 through the desiccant rotor 2 may comprise controlling the volume flow of the purge air 20 through a purge sector 22 of the desiccant rotor 2 in relation to the volume flow of the regeneration air 14 through the regeneration sector 16 of the desiccant rotor 2.

The predetermined target humidity is a humidity in the regeneration sector 16 of the desiccant rotor 2, which may be larger than 0% RH.

FIG. 5 schematically illustrates a control device 200 of a desiccant dehumidifier 1 according to an example. The control device 200 comprises at least one processor 201 and a computer-readable medium 202. The control device 200 may be configured to perform the method as described in FIG. 3 upon execution of a computer program by the at least one processor 201. The computer program comprises computer-readable instructions that may be stored in the computer-readable medium 202, such as a non-transitory hardware memory device of the control device 200.

1.-16. (canceled)

17. A method, performed by a control device, for controlling a desiccant dehumidifier, the desiccant dehumidifier comprising:
a desiccant rotor, which is rotatably arranged about a center axis of the desiccant rotor;
a process air circuit arranged to conduct process air through a process sector of the desiccant rotor;
a regeneration air circuit arranged to conduct regeneration air through a regeneration sector of the desiccant rotor;
a fan arranged in the regeneration air circuit, downstream of the desiccant rotor, the fan being configured to generate a flow of regeneration air in the regeneration air circuit; and
a heater device arranged in fluid communication with the regeneration air circuit upstream of the desiccant rotor, the method comprising the steps of:
controlling the heater device to provide a substantially constant temperature of the regeneration air; and
controlling the volume flow of regeneration air with the substantially constant temperature through the regeneration sector based on a predetermined target humidity in the regeneration sector of the desiccant rotor.

18. The method according to claim 17, wherein the desiccant dehumidifier further comprises a humidity sensor arranged in the process air circuit downstream of the desiccant rotor, and
wherein the step of controlling the volume flow of regeneration air through the regeneration sector is further based on a current humidity in the desiccant rotor determined by the humidity sensor.

19. The method according to claim 17, wherein the desiccant dehumidifier further comprises a humidity sensor arranged in the regeneration air circuit downstream of the desiccant rotor, and
wherein the step of controlling the volume flow of regeneration air through the regeneration sector is further based on a current humidity in the desiccant rotor determined by the humidity sensor.

20. The method according to claim 17, wherein the desiccant dehumidifier further comprises a humidity sensor arranged in a space that is fluidly connected to the process air circuit, and
wherein the step of controlling the volume flow of regeneration air through the regeneration sector is further based on a target running time of the desiccant dehumidifier for reaching a target humidity in the space determined by the humidity sensor.

21. The method according to claim 17, wherein the desiccant dehumidifier further comprises a dew point sensor arranged in a space that is fluidly connected to the process air circuit, and
wherein the step of controlling the volume flow of regeneration air through the regeneration sector is further based on a target dew point humidity determined by the dew point sensor.

22. The method according to claim 17, wherein the step of controlling the volume flow of regeneration air through the regeneration sector comprises controlling the speed of the fan for controlling the volume flow of the regeneration air.

23. The method according to claim 17, wherein the desiccant dehumidifier further comprises a damper arranged in the regeneration air circuit downstream of the desiccant rotor, and
wherein the step of controlling the volume flow of regeneration air through the regeneration sector comprises controlling the damper for controlling the volume flow of regeneration air.

24. The method according to claim 17, wherein the desiccant dehumidifier further comprises a purge air circuit arranged to conduct purge air through a purge sector of the desiccant rotor, the purge air circuit being arranged in fluid communication with the process air circuit upstream of the desiccant rotor and with the regeneration air circuit upstream of the heater device, and
wherein the method comprises the further step of controlling the volume flow of purge air together with regeneration air through the desiccant rotor based on the predetermined target humidity in the desiccant rotor.

25. The method according to claim 24, wherein the step of controlling the volume flow of the purge air together with regeneration air through the desiccant rotor comprises controlling the speed of the fan for controlling the volume flow of the purge air and the regeneration air through the desiccant rotor.

26. The method according to claim 24, wherein the step of controlling the volume flow of the purge air together with regeneration air through the desiccant rotor comprises controlling the volume flow of the purge air through the purge sector of the desiccant rotor in relation to the volume flow of the regeneration air through the regeneration sector of the desiccant rotor.

27. The method according to claim 17, wherein the step of controlling the volume flow of regeneration air with the substantially constant temperature through the regeneration sector based on a predetermined target humidity in the regeneration sector of the desiccant rotor comprises controlling the volume flow of regeneration air with the substantially constant temperature through the regeneration sector based on a predetermined target humidity in the regeneration sector which is higher than 0% RH.

28. A computer program comprising instructions, which when the program is executed by a data processing unit of a control device of a desiccant dehumidifier, cause the control device to carry out the method according to claim 17.

29. A computer-readable medium having stored thereon the computer program of claim 28.

30. A desiccant dehumidifier comprising:
a desiccant rotor, which is rotatably arranged about a center axis of the desiccant rotor;
a process air circuit arranged to conduct process air through a process sector of the desiccant rotor;
a regeneration air circuit arranged to conduct regeneration air through a regeneration sector of the desiccant rotor;
a fan arranged in the regeneration air circuit downstream of the desiccant rotor, the fan being configured to generate a flow of regeneration air in the regeneration air circuit;
a heater device arranged in fluid communication with the regeneration air circuit upstream of the desiccant rotor; and
a control device configured to control the heater device to provide a substantially constant temperature of the regeneration air, and to control the volume flow of regeneration air through the regeneration sector based on a predetermined target humidity in the regeneration sector of the desiccant rotor.

31. The desiccant dehumidifier according to claim 30, wherein the heater device comprises a PTC heater.

32. The desiccant dehumidifier according to claim 30, wherein the predetermined target humidity in the regeneration sector of the desiccant rotor is higher than 0% RH.
